(19) United States
(12) Patent Application Publication
(10) Pub. No.: US 2012/0063019 A1
(43) Pub. Date: Mar. 15, 2012

(54) CONTROL METHOD FOR A VOICE COIL MOTOR AND LENS FOCUSING SYSTEM USING THE SAME

(75) Inventors: CHING-HSUN HSU, Miaoli County (TW); HUNG-AN HUANG, Miaoli County (TW)

(73) Assignee: FITIPOWER INTEGRATED TECHNOLOGY INC., MIAOLI COUNTY (TW)

(21) Appl. No.: 13/229,821

(22) Filed: Sep. 12, 2011

(30) Foreign Application Priority Data
Sep. 15, 2010 (TW) 099131244

(51) Int. Cl. G02B 7/04; G05B 5/01

(52) U.S. Cl. 359/824; 318/611

(57) ABSTRACT

A control method is provided to reduce the spring resonance of a voice coil motor when the coil current of the voice coil motor is changed. Each time a total variation for the coil current to be changed is identified and divided into a plurality of step variations applied one by one with a time step equal to one half of the spring resonant period of the voice coil motor. Due to reduction of the spring resonance, the control method speed up the voice coil motor to a steady state. With this control method, a lens focusing system has a shorter focusing time.

### FIELD OF THE INVENTION

The present invention is related generally to a control method for a voice coil motor and, more particularly, to a control method for a voice coil motor for a lens focusing system.

### BACKGROUND OF THE INVENTION

In a lens focusing system, as shown in FIG. 1, a control circuit 10 controls the coil current IL of a voice coil motor (VCM) 12 in order to adjust the position of a lens 14. In the voice coil motor 12, a spring 16 has one end fixed immovably and the other end fixed on a movable electromagnet 18 at whose opposite side is arranged a magnet 20, so that the magnetic force produced by the coil current IL flowing through the coil 22 of the electromagnet 18 will interact with the magnet 20 to move the electromagnet 18 frontward or backward by controlling the value of the coil current IL. The lens 14 is driven by the electromagnet 18 in the manner that the movement of the electromagnet 18 will change the position of the lens 14. To move the lens 14 frontward or backward, the control circuit 10 changes the coil current IL to change the magnetic force produced by the electromagnet 18, thereby suddenly applying a force to the spring 16, and then a new balance between the magnetic force and the recovery force of the spring 16 will be built up and thus determine the displacement d of the lens 14. However, referring to FIGS. 1 and 2, when the coil current IL is changed by a variation A suddenly, the spring 16 will resonate with a gradually decayed amplitude over time and thus swing the lens 14 for a time interval. Only when the spring 16 stops resonating, the lens 14 becomes steady in position. Consequently, each time the lens 14 is moved, it requires waiting for a long focusing time.

To reduce the resonance of the spring 16, a popular solution is to change the coil current IL with a slower varying speed to decrease the instant force acting on the spring 16 and thereby reduce the resonant amplitude of the spring 16. However, since the coil current IL is changed with a fixed varying slope, it will take a longer time for moving the lens 14 with a larger displacement d, due to the coil current IL requiring more time to reach the larger variation A. Recently, the volume of the lens 14 is more and more small and the weight of the lens 14 is more and more light. As a result, a small force acting on the spring 16 would cause the spring 16 to resonate with a large amplitude and thereby, the coil current IL needs a more slower varying speed to reduce the instant force acting on the spring 16, and the voice coil motor 12 requires more time to reach a steady state accordingly.

Therefore, it is desired a control method for a voice coil motor that can dramatically reduce the spring resonance of the voice coil motor and significantly speed up the voice coil motor to a steady state.

### SUMMARY OF THE INVENTION

An objective of the present invention is to provide a control method for a voice coil motor that can dramatically reduce the spring resonance of the voice coil motor.

Another objective of the present invention is to provide a control method a voice coil motor that can significantly speed up the voice coil motor to a steady state.

A further objective of the present invention is to provide a lens focusing system having a shorter focusing time.

According to the present invention, a control method for a voice coil motor involves dividing a total variation for the coil current of the voice coil motor into a plurality of step variations applied one by one with a time step equal to one half of the spring resonant period of the voice coil motor.

According to the present invention, a lens focusing system includes a voice coil motor and a control circuit to divide a total variation for the coil current of the voice coil motor into a plurality of step variations applied one by one with a time step equal to one half of the spring resonant period of the voice coil motor.

In virtue of the characteristics of the spring resonance, the inventive method can dramatically reduce the spring resonance of a voice coil motor and significantly speed up a voice coil motor to a steady state, and thereby shorten the focusing time of a lens focusing system.

### BRIEF DESCRIPTION OF THE DRAWINGS

These and other objectives, features and advantages of the present invention will become apparent to those skilled in the art upon consideration of the following description of the preferred embodiments of the present invention taken in conjunction with the accompanying drawings, in which:

FIG. 1 is a schematic diagram of a lens focusing system;

FIG. 2 is a schematic diagram showing a conventional control method for a voice coil motor and the lens displacement it causes;

FIG. 3A is a schematic diagram of a first embodiment according to the present invention;

FIG. 3B is a schematic diagram of the embodiment shown in FIG. 3A where n=1;

FIG. 3C is a schematic diagram of the embodiment shown in FIG. 3A where n=2;

FIG. 4 is a schematic diagram showing how the control method of FIG. 3A reduces the spring resonance;

FIG. 5 is a schematic diagram showing the lens displacement when using the control method of FIG. 3A;

FIG. 6 is an HSPICE simulation result when using the control method of FIG. 2;

FIG. 7 is an HSPICE simulation result when using the control method of FIG. 3B;

FIG. 8A is a schematic diagram of a second embodiment according to the present invention;

FIG. 8B is a schematic diagram of the embodiment shown in FIG. 8A where n=1;

FIG. 8C is a schematic diagram of the embodiment shown in FIG. 8A where n=2;

FIG. 9 is a schematic diagram showing how the control method of FIG. 8A reduces the spring resonance;

FIG. 10A is a schematic diagram of a third embodiment according to the present invention;

FIG. 10B is a schematic diagram of the embodiment shown in FIG. 10A where n=1;

FIG. 10C is a schematic diagram of the embodiment shown in FIG. 10A where n=2; and

FIG. 11 is a schematic diagram showing how the control method of FIG. 10A reduces the spring resonance.

### DETAILED DESCRIPTION OF THE INVENTION

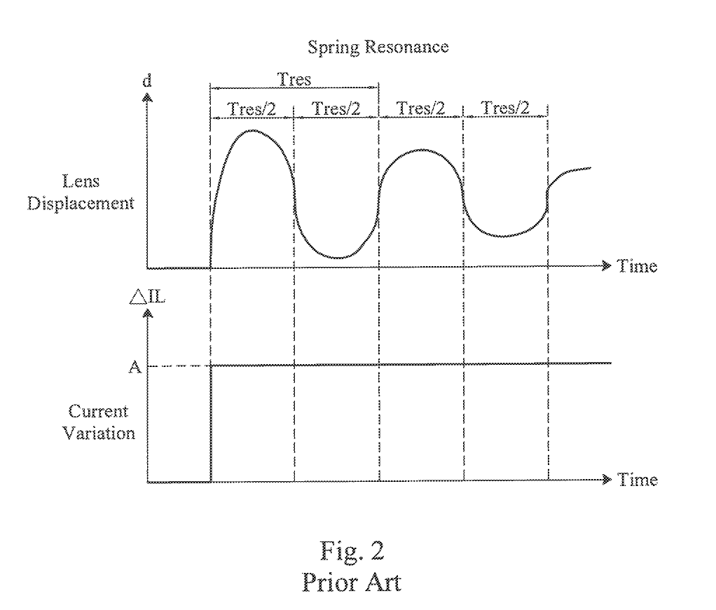

For each voice coil motor, referring to FIG. 2, the spring thereof has a specific resonant period Tres, and the present invention uses the characteristics to reduce the spring resonance of the voice coil motor.

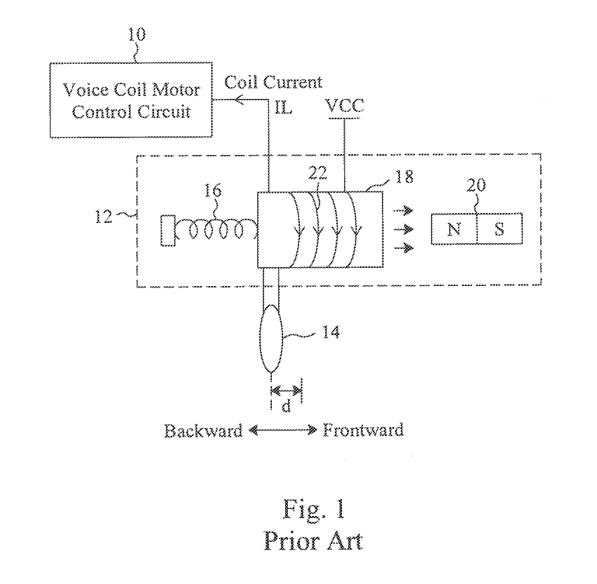

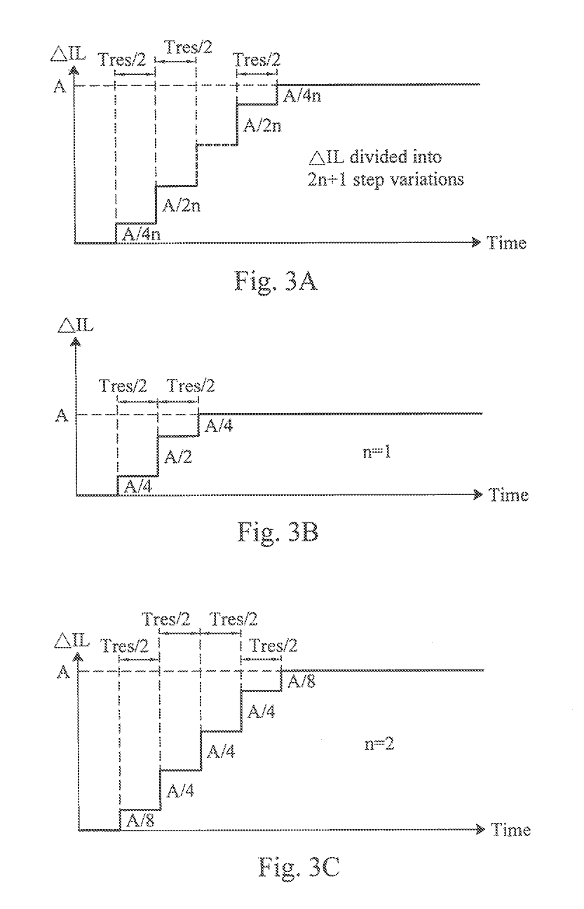

FIG. 3A is a schematic diagram of a first embodiment according to the present invention. Referring to FIGS. 1 and 3A, in order to move the lens 14 with a target displacement d which requires a coil current IL, the control circuit 10 identifies the needed variation A for the coil current IL to be changed, and divides the total variation A into 2n+1 step variations, where n is a positive integer, and applies the 2n+1 step variations one by one with a time step equal to one half of the resonant period Tres of the spring 16. In this embodiment, the first and the last step variations both have a value equal to

$$\frac{A}{4 n} ,$$

while the rest of the step variations have a value equal to

$$\frac{A}{2 n} .$$

For example, referring to FIG. 3B, when n=1, the number of the step variations for the coil current IL is three (2×1+1), the first and the third step variations both have a value equal to A/4, and the second step variation has a value equal to A/2; when n=2, as shown in FIG. 3C, the total variation A for the coil current IL is divided into five (2×2+1) step variations, the first and the fifth step variations both have a value equal to A/8, and the second to the fourth step variation each has a value equal to A/4. The value of the parameter n is determined by the designer and may be constant or programmable.

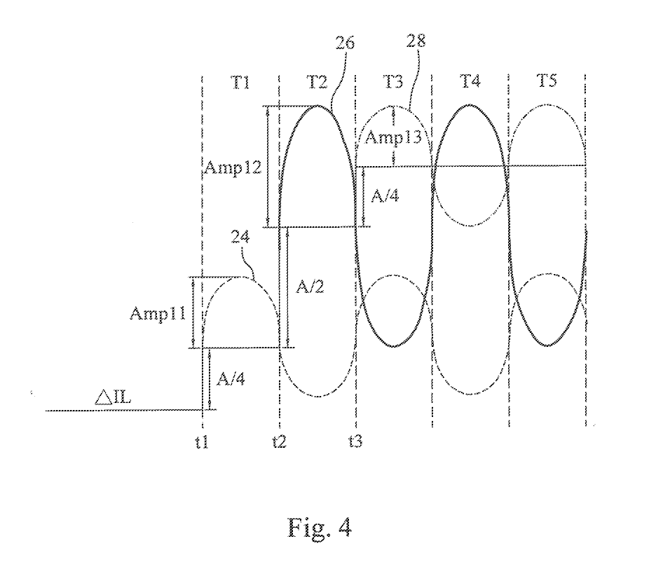

FIG. 4 illustrates the principles on which how the control method of FIG. 3A eliminates the spring resonance. Taking the case of n=1 for example, at time t1, the coil current IL is changed by the first step variation A/4, and as shown by waveform 24, this step variation brings a resonance with an amplitude Amp11 to the spring 16; at time t2, the coil current IL is changed by the second step variation A/2, and as shown by waveform 26, this step variation brings a resonance with an amplitude Amp12 to the spring 16; at time t3, the coil current IL is changed by the third step variation A/4, and as shown by waveform 28, this step variation brings a resonance with an amplitude Amp13 to the spring 16. Since the first and third step variations both have a value equal to A/4, and the second step variation has a value equal to A/2, the corresponding amplitudes have the relationship

$$Amp 11 = Amp 13 = \frac{Amp 12}{2} .$$

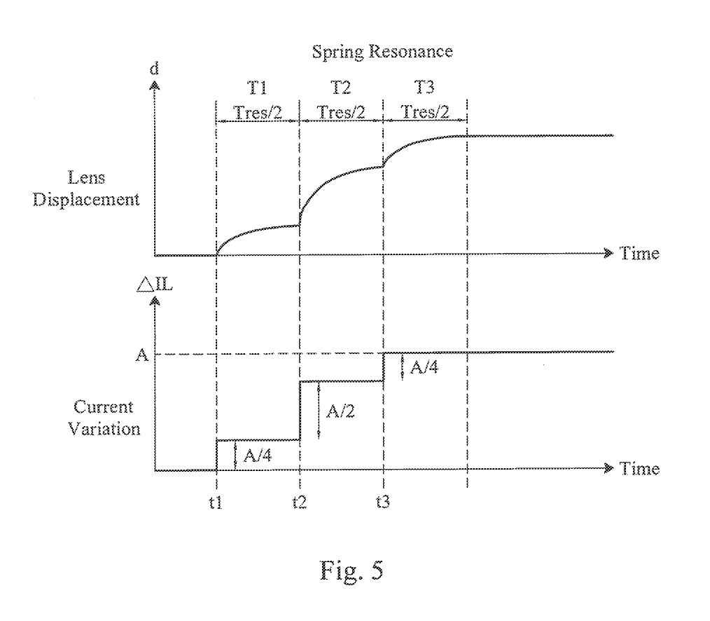

Referring to FIG. 4, taking the third time step T3 for example, waveform 24 has the amplitude +Amp11, waveform 26 has the amplitude −Amp12, and waveform 28 has the amplitude +Amp13, so that all of them mutually cancel in amplitude, and as shown in FIG. 5, there is almost no resonance in the spring 16. As a result, the lens 14 becomes steady almost as soon as it is moved to the set position.

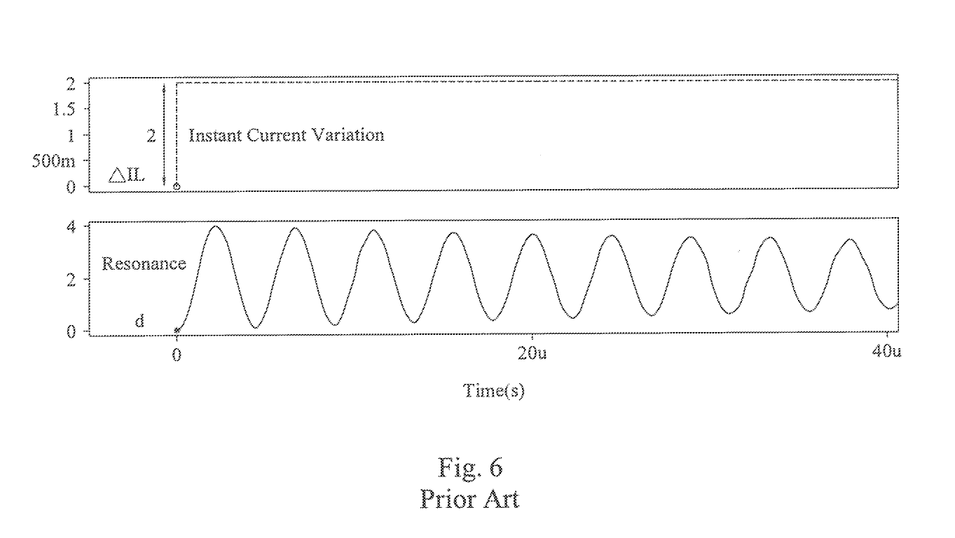

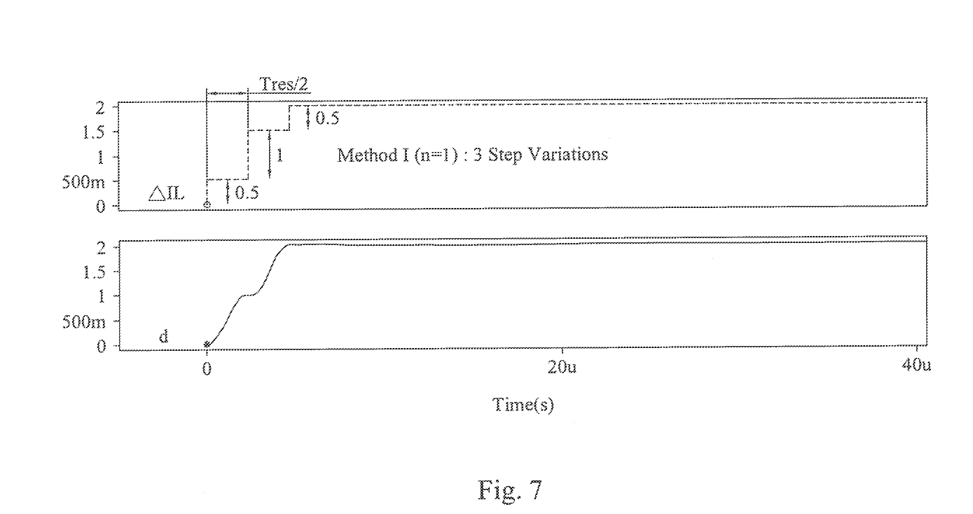

Using HSPICE to simulate a same voice coil motor with the control methods as depicted in FIGS. 2 and 3B respectively, the results are shown in FIGS. 6 and 7 respectively. Referring to FIG. 6, the conventional method where the total variation for the coil current is applied at one time always causes a spring resonance that has a very large amplitude and requires a very long time for the spring to become steady. Referring to FIG. 7, the control method of FIG. 3B achieves the target of the coil current with three step variations, and brings almost no resonance to the spring. By comparing the simulation results shown in FIGS. 6 and 7, it is evidenced that the control method according to the present invention can effectively eliminate the spring resonance and speed up a voice coil motor to a steady state.

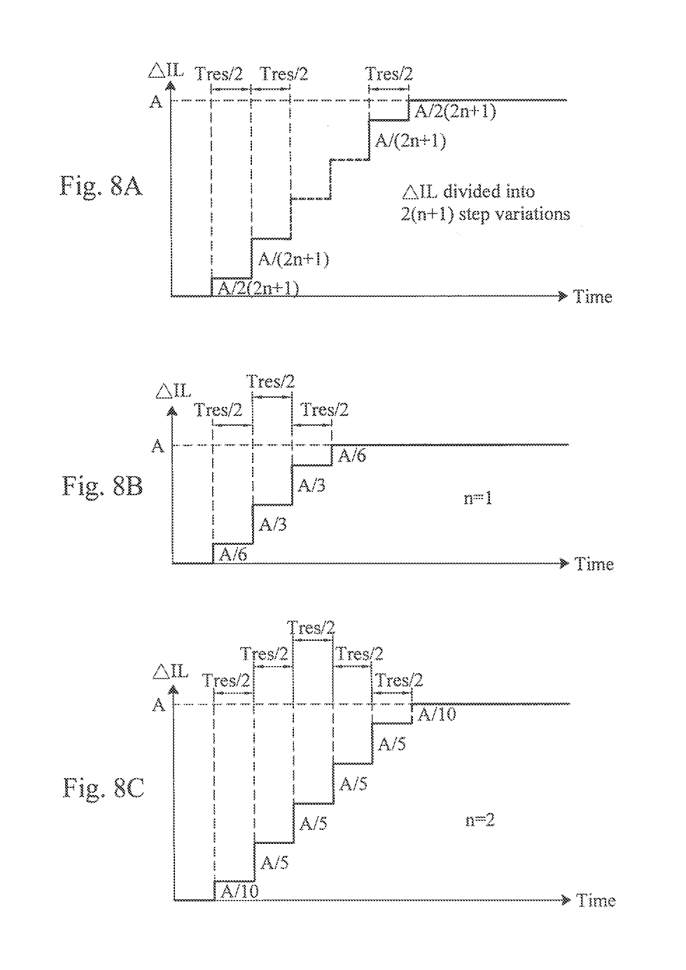

FIG. 8A is a schematic diagram of a second embodiment according to the present invention. Referring to FIGS. 1 and 8A, in order to move the lens 14 with a target displacement d which requires a coil current IL, the control circuit 10 identifies the needed variation A for the coil current IL to be changed, and divides the total variation A into 2(n+1) step variations, where n is a positive integer, and applies the 2(n+1) step variations one by one with a time step equal to one half of the resonant period Tres of the spring 16. The first and the last step variations both have a value equal to

$$\frac{A}{2 ( 2 n + 1 )} ,$$

while the rest of the step variations each has a value equal to

$$\frac{A}{2 n + 1} .$$

As shown in FIG. 8B, when n=1, the number of the step variations for the coil current IL is four (2(1+1)), the first and the fourth step variations each has a value equal to A/6, and the second and the third step variations each has a value equal to A/3; when n=2, as shown in FIG. 8C, the total variation A for the coil current IL divided into six (2(2+1)) step variations, the first and the sixth step variations each has a value equal to A/10, and the second to the fifth step variation each has a value equal to A/5.

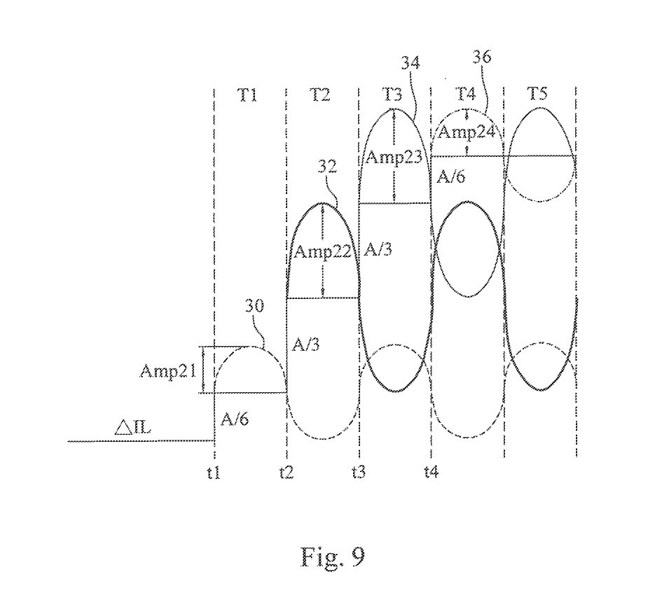

FIG. 9 is a schematic diagram showing how the control method of FIG. 8A reduces the spring resonance. Taking the case of n=1 for example, at time t1, the coil current IL is changed by the first step variation A/6, and as shown by waveform 30, this step variation brings a resonance with an amplitude Amp21 to the spring 16; at time t2, the coil current IL is changed by the second step variation A/3, and as shown by waveform 32, this step variation brings a resonance with an amplitude Amp22 to the spring 16; at time t3, the coil current IL is changed by the third step variation A/3, and as shown by waveform 34, this step variation brings a resonance with an amplitude Amp23 to the spring 16; at time t4, the coil current IL is changed by the fourth step variation A/6, and as shown by waveform 36, this step variation brings a resonance with an amplitude Amp24 to the spring 16. Since the first and fourth step variations both have a value equal to A/6, and the second and the third step variations both have a value equal to A/3, the corresponding amplitudes have the relationship

$$Amp 21 = Amp 24 = \frac{Amp 22}{2} = \frac{Amp 23}{2} .$$

Taking the fourth time step T4 for example, waveform 30 has the amplitude −Amp21, waveform 32 has the amplitude +Amp22, waveform 34 has the amplitude −Amp23, and waveform 36 has the amplitude +Amp24, so that all of them mutually cancel in amplitude, and thereby the spring 16 almost does not resonate.

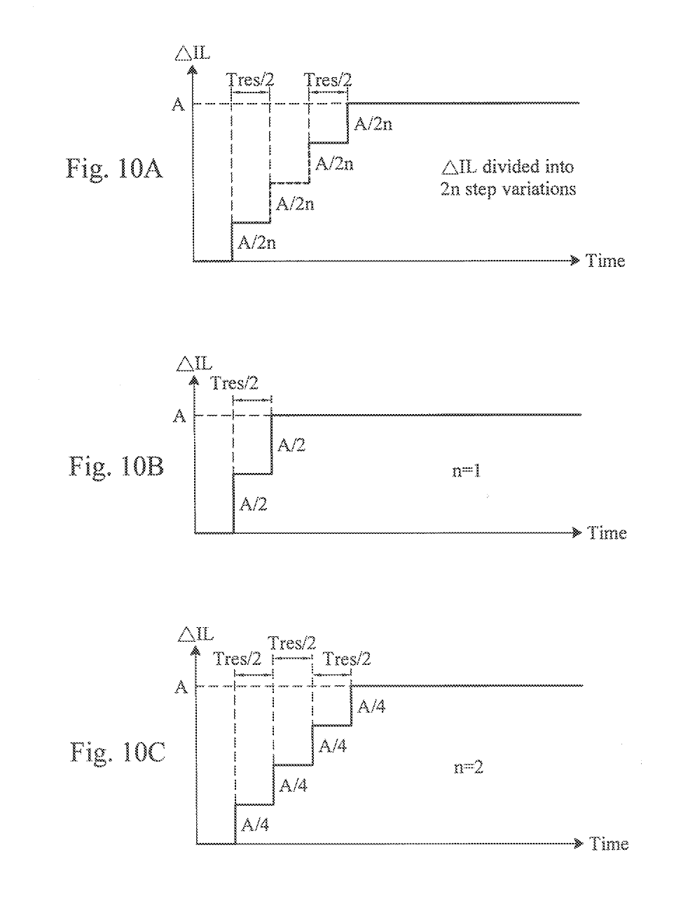

FIG. 10A is a schematic diagram of a third embodiment according to the present invention. Referring to FIGS. 1 and 10A, in order to move the lens 14 with a target displacement d which requires a coil current IL, the control circuit 10 identifies the needed variation A for the coil current IL to be changed, and divides the total variation A into 2n step variations having a same value

$$\frac{A}{2 n} ,$$

where n is a positive integer, and applies the 2n step variations one by one with a time step equal to one half of the resonant period Tres of the spring 16. When n=1, as shown in FIG. 10B, the number of the step variations for the coil current IL is two (2×1), and each step variation has a value equal to A/2; when n=2, as shown in FIG. 10C, the number of the step variations for the coil current IL is four (2×2), and each step variation has a value equal to A/4.

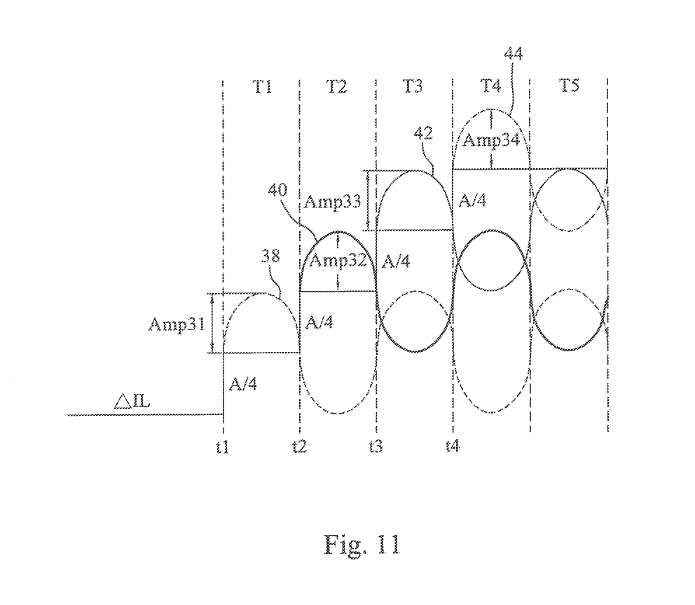

FIG. 11 is a schematic diagram showing how the control method of FIG. 10A reduces the spring resonance. Taking the case of n=2 for example, at time t1, the coil current IL is changed by the first step variation A/4, and as shown by waveform 38, this step variation brings a resonance with an amplitude Amp31 to the spring 16; at time t2, the coil current IL is changed by the second step variation A/4, and as shown by waveform 40, this step variation brings a resonance with an amplitude Amp32 to the spring 16; at time t3, the coil current IL is changed by the third step variation A/4, and as shown by waveform 42, this step variation brings a resonance with an amplitude Amp33 to the spring 16; and at time t4, the coil current IL is changed by the fourth step variation A/4, and as shown by waveform 44, this step variation brings a resonance with an amplitude Amp34 to the spring 16. Since each step variation has the same value equal to A/4, the corresponding amplitudes will have the relationship Amp31=Amp32=Amp33=Amp34. Taking the fourth time step T4 for example, waveform 38 has the amplitude −Amp31, waveform 40 has the amplitude +Amp32, waveform 42 has the amplitude −Amp33, and waveform 44 has the amplitude +Amp34, so that all of them mutually cancel in amplitude, and thereby the spring 16 almost does not resonate.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A control method for a voice coil motor having a spring resonant period, the control method comprising the steps of:
(A) identifying a total variation A for a coil current of the voice coil motor to be changed; and
(B) dividing A into 2n+1 step variations applied one by one with a time step equal to one half of the spring resonant period, wherein n is a positive integer, each of the first and the last step variations has a value equal to
$$\frac{A}{4 n} ,$$
and each of the rest of the step variations has a value equal to
$$\frac{A}{2 n} .$$

2. A control method for a voice coil motor having a spring resonant period, the control method comprising the steps of:
(A) identifying a total variation A for a coil current of the voice coil motor to be changed; and
(B) dividing A into 2(n+1) step variations applied one by one with a time step equal to one half of the spring resonant period, wherein n is a positive integer, each of the first and the last step variations has a value equal to
$$\frac{A}{2 ( 2 n + 1 )} ,$$
and each of the rest of the step variations has a value equal to
$$\frac{A}{2 n + 1} .$$

3. A control method for a voice coil motor having a spring resonant period, the control method comprising the steps of:
(A) identifying a total variation A for a coil current of the voice coil motor to be changed; and
(B) dividing A into 2n step variations applied one by one with a time step equal to one half of the spring resonant period, wherein n is a positive integer, and each of the step variations has a value equal to
$$\frac{A}{2 n} .$$

4. A lens focusing system comprising:
a voice coil motor having a spring resonant period; and
a control circuit connected to the voice coil motor for controlling a coil current of the voice coil motor;
wherein in order to change the coil current by a total variation, the control circuit divides the total variation into a plurality of step variations applied one by one with a time step equal to one half of the spring resonant period.
